(19) United States
(12) Patent Application Publication
(10) Pub. No.: US 2014/0041963 A1
(43) Pub. Date: Feb. 13, 2014

(54) Deployable Hybrid Mobile Elevating Access Platform

(71) Applicant: Daniel Warden, Bend, OR (US)

(72) Inventor: Alan O'Shea, Tullamore (IE)

(73) Assignees: Cv International, Inc, Bend, OR (US); Daniel Warden, Bend, OR (US)

(21) Appl. No.: 13/971,802

(22) Filed: Aug. 20, 2013

(51) Int. Cl. E06C 1/393; E06C 5/04

(52) U.S. Cl. CPC E06C 1/393; E06C 5/04
USPC 182/64.1

(57) ABSTRACT

The invention is a mobile maintenance stand that combines the function of an adjustable stairway and hydraulic scissor lift that independently elevates and descends an access work platform to support maintenance tasks on commercial and military aircraft. The elevating access work platform has an extended reach of 144′ and is initiated by a secondary hydraulic scissor lift that promotes upward extension beyond the parameters of the adjustable stairway reach, to provide further maintenance access. The additional extension range of the access work platform with a hydraulic scissor device, provides vertical movement to the work deck at all check levels. Further, this invention is self-contained that collapses to a compact dimension and be transported on an air cargo pallet. Thus, the invention's mechanical scheme of the scissor lift to extend access work platform beyond the adjustable stairway is novel and, is unlike any existing articulating stairway and, or scissor embodiments.

### BACKGROUND OF THE INVENTION

The invention arose out of the necessity to create a mobile elevating access work platform with easier accessibility and expanding repair range that prior or present platform system failed to provide in support of maintenance task upon aircraft. This mobile elevating access platform invention with a second hydraulic scissor lift and an independent operating device addressed this particular problem. Prior maintenance stands had stairways without an adjustable access work platforms to add extra height range for maintenance service. Further, the articulating stairway has an independent operating scissor device separate from the access work platform. As a result, this second hydraulic scissor lift device helps to expand the height range of the access work platform which is mandatory and useful for maintenance repairs in the aviation industry. Thus, the Mobile Access Maintenance Stand will be filed under the United States Patent Code definition as a Machine.

### SUMMARY OF THE INVENTION

The invention relates to Mobile Maintenance Stand which uniquely combined functions of an articulating stairway and access work platform both powered and operated by hydraulic scissor devices and controls. Further, the access work platform has an added dimension with the capability to lift vertically above the expanding stairway structure and provides an add advantage to aircraft repair that other maintenance stands failed to offer. A further advantage of Mobile Maintenance Stand invention is its capability of being collapsible to an appreciable small envelope designed to fit within the allowable limits of a standard military transport pallet HCU-6/E 463L.

### DETAILED DESCRIPTION OF THE INVENTION

Referring to FIG. 1, this drawing illustrates one embodiment of the present invention in a non-collapsed configuration; FIG. 2, illustrates one embodiment of the invention in a collapsed and deployable configuration. The present invention which is referred to as a deployable combination mobile elevating access platform comprises in one embodiment of a chassis element 29 connected to and supporting a height adjustable stairway element 30, which in turn is connected to and supports an elevating platform element 31.

The elevating platform element 31 in one embodiment is comprised of a lower rail assembly 34, a deck assembly 35 and opposing scissor frames 36 & 37 which in a preferred embodiment have rollers 38 to allow roll movement in the lower rail assembly 34 and the deck assembly 35. In a preferred embodiment the lower rail assembly 34 is designed to articulate and remain substantially parallel with the steps 39 of the height adjustable stairway element 30 by means of a designed geometrically appropriate telescoping support trestle element 33 which is also attached to the chassis element 29.

The chassis element 29 in a preferred embodiment is supported on at least 4 suitably sized wheels or caster wheels 40. The invention is further adapted to include at least 1, but the preferred embodiment having 4 mechanical screw type stabilizer leg assemblies 41. In the preferred embodiment the forward 2 mechanical screw type stabilizer assemblies 41 are fitted to outriggers 42 which enhance the stability of the invention when in use. In one embodiment the outriggers 42 are stowed for transportation or when not in use by folding back parallel with the chassis frame element 29 and winding the stabilizer leg assembly 41 under and into the capture cleat 52.

In one embodiment, the height adjustable stairway element 30 is comprised of steps 39, stringers 43, tie rod 44, telescoping support trestle element 33, pivoting hand rail 45, rotating handrail posts 46 and pivoting hardware 47. In a preferred embodiment the height adjustable stairway element 30 is articulated in a controlled radially up and down movement initiated by a suitably sized hydraulic piston ram 48 located and attached between the telescoping trestle element 33 and the chassis element 29. In a preferred embodiment the hydraulic piston ram 48 is actuated by a manually operated oil pump 49. Similarly the elevating platform element 31 is in one embodiment operates by a second independent hydraulic piston ram 50. In a preferred embodiment the hydraulic ram assembly is actuated by means of a manually operated hydraulic pump 51, that controls vertically up and down movement of the elevating platform element 31.

In one embodiment, the height adjustable stairway element 30 is further adapted to incorporate a mechanical lock out feature 52, comprising of a pivoting ridged fixed length mechanical lock out leg 53, a multi-position glide cleat assembly 54, a lubricated low friction glide shoe 55, lock out glide rail 56, and locking pin 57.

The mechanical lockout feature 52 functions in the presented preferred configuration as follows: when the height adjustable stairway element 30 is in a static position, the multi-position glide cleat 54, being mechanically connected to the pivoting ridged fixed length mechanical lock out leg 53, is secure to prevent movement within the lock out glide rail 56 located on chassis element 29 by locking pin 57.

Inversely when the height adjustable stairway element 30 is required to articulate, the locking pin 57 is temporarily removed and the height adjustable stairway element 30 acted upon by the hydraulic cylinder 48. The multi-position glide cleat assembly 54 being mechanically connected to the pivoting ridged fixed length mechanical lockout leg 53 is forced to travel along the lockout glide rail 56 as the angle of the pivoting ridged fixed length mechanical lockout leg 53 changes and the distance from the pivot point 32 to the lockout glide rail 56 increases or decreases as a consequence of a change in elevation of the height adjustable stairway element 30. When a desired height is attained the multi-position glide cleat assembly 54 is again secured in position by the locking pin 57 in the lockout glide rail 56. Guaranteeing an infinite number of height positions for the height adjustable stairway element 30 is possible due to the suitably dimensioned slots 58 in the lock out glide rail 56 and the appropriately spaced array of pin positions 59 provided in the multi-position glide cleat assembly 54.

Similarly the elevating platform element 31 is adapted to incorporate a mechanical lock out feature 60, comprising of mechanical lock out pin 61, threaded support let 62, hollow guardrail gate post 63, actuating stop nut 64 and articulating cleat and pin 65.

The mechanical lock out feature 60 functions in the presented preferred embodiment. When the elevating platform element 31 in a static position is prevented from collapsing by the mechanical lock out pin 61 placed through pre-drilled holes in the threaded support leg 62 secures the threaded support leg 62 from sliding inside the hollow guardrail gate post 63, and thereafter, prevents movement of the connected elevating platform element 31. Additionally the articulating stop nut 60 being set to any desired height along the threaded support leg prevents the elevating platform element 31 from collapsing and can be set to an infinite number of height positions. The threaded support let 62 is connected to the lower rail assembly 34 by articulating cleat and pin 65. This arrangement ensures that the threaded support let 62 is always coaxial with hollow guardrail gate post 63 during adjustment of height adjustable stairway element 30 and or elevating platform element 31.

In a preferred embodiment invention is enhanced with the inclusion of OSHEA & ANSI compliant adjustable stairway handrails 60, which by means of a pivoting joint are connected to fixed guardrail post 66 which is part of chassis element 29, and pivoting guardrail post 67. The arrangement ensures that the handrails 60 are always parallel to the height adjustable stairway element 30.

The invention and this embodiment is further adapted with the inclusion of OSHA & ANSI compliant fall protection removable guardrails 68, on all sides of the elevating platform element 31 deck assembly 35. The invention is further enhanced with the inclusion of a positive locking swing gate 69 and integrated drop ladder 70.

In one embodiment the guardrails 68 are located into arranged pockets 71 located on the deck assembly 35 and secured in position using locking pins 72. The swing gate 69 and integrated drop ladder 70 are fitted to the egress side of the elevating platform element 31 and provide safety for the operator while elevated and emergency ingress from the elevating platform element 31 in an emergency.

In a preferred embodiment a folding lower step 73 is included and fitted to the chassis element 29 for the purposes of compacting for the collapsed configuration (FIG. 2). The invention is further adapted by the inclusion of at least 1 suitably sized tie down pin 74 and at least one lifting point 75. The invention is adapted to include an integrated stowed towing element 76, which is located onto arranged and suitably sized spigots 77 located on the chassis element 29. The towing element 76 is adapted with telescoping members 78 to increase its size and is fitted using retaining pins 79 to cleats 80 fitted to the chassis element 29. In one embodiment the towing element 76 can be used as a winch point and a secondary winch point 81 is provided on the front of the chassis element 29.

The following text describes a preferred sequence of procedures associated with the invention to configure it from an operation to a collapsed configuration; the description is offered as one possible sequence and not the only possible sequence.

In one embodiment, the invention is configured from an operational configuration (FIG. 1) to collapsible configuration (FIG. 2) by first collapsing the elevating platform element 31 to its lowest position. Then by lowering the height adjustable stairway element 30 to its minimum height position and removing temporarily guardrails 68, swing gate assemblies 69 & 70 and mechanical lock out feature 60. In a preferred embodiment un-couple the manual pump 51 used to actuate the elevating platform element 31.

Next lock the elevating platform element 31 assembly together using hood straps 82 to prevent unwanted actuation and raise the deck assembly back to approximately 72″ above ground using the manually operated oil pump 49.

Next release a temporarily remove securing pins 83 secured from locating holes 84 found on the inner slide frame 85 of the telescoping support trestle element 33 and locating holes 86 on the outer slide frame 87 of the telescoping support trestle element 33.

Using the manually operated oil pump 49 reverse the hydraulic piston ram 48 to rotate downward the elevating platform element 31 until the inner slide frame 85 of the telescoping support trestle element 33 travels downward along the outer slide frame 87 until the 2^{nd} set of locating holes 88 on the outer slide frame 87 align with the locating holes 84 of the inner slide frame 85. Replace securing pins 83 to locating holes 88 to lock the geometry.

Now remove hydraulic piston ram securing pin 89 and using manually operated oil pump 49 extend again the hydraulic piston ram 48 until it aligns and can be secured using the removed securing pin 89 to the lowering cleats 90 located on the outer slide frame 87.

Next temporarily remove securing pins 83 again. Once again using manually the manually operated oil pump 49 reverse the hydraulic piston ram 48 to continue to rotate downward the elevating platform element 31 until the outer slide frame 86 of the telescoping support trestle element 33 slides downward until 3^{nd} set of locating holes 91 found on outer slide frame 87 align with locating holes 84 found on inner slide frame. Replace securing pins 83 into locating holes 91 to lock the geometry.

Extend pivoting mechanical actuator jack 92 by releasing locking pin 57 and winding actuator using handle 93 until inner leg 94 extends sufficiently and can be secured using locking pin 57 and multi-position glide cleat assembly 54 to lock out glide rail 56. Next remove hydraulic piston ram securing pin 89 and rotate downward the hydraulic piston ram 48 until it can be located in the stowing cleat 95 located on the chassis element 29.

Next remove the locating pins 83 and allow the elevating platform element 31 to swing in until the 4^{th} set of locating holes 96 found on the outer slide frame 87 align with the locating holes 84 found on the inner slide frame 85. Replace securing pins 83 to the 4^{th} set of locating holes 96 to lock the geometry.

Using the handle 93 wind and retract the inner leg 94 of the pivoting mechanical actuator jack 92 until the entire assembly comes to rest on angle shelf 97. Release locking pin 57 and continue to retract until aligned with pivoting ridged fixed length mechanical lock out leg 53 replace lock out pin 57.

Unbolt OSHEA & ANSI compliant adjustable stairway handrails 60 form and the pivoting guardrail post 67 located height adjustable stairway element 30 and allow both to hang down freely.

Replace 2 of the guardrails 68 inverted in the arranged pockets either side of the elevating platform element 31, and replace inverted the swing gate assemblies 69. Next locate mechanical lock out features assembly 60 into provided storage location 98. Locate 3^{rd} guardrail to sockets 99 provided on chassis element 29. Retract outriggers 42 by folding back parallel with the chassis frame element 29 and winding the stabilizer leg assembly 41 under and into the capture cleat 52.

In the above preferred sequence and embodiment the preceding instructions are reversed to reconfigure into the operational configuration.

### LIST OF FIGURES

FIG. 1 General Isometric views of device in maximum extended configuration

FIG. 2 Elevation and isometric views of device in collapsed deployable configuration

FIG. 3 Detail view from under side of scissor deck extended

FIG. 4 Detail view from under side of chassis frame and stairway

FIG. 5 Detail view of sliding and locking mechanisms

FIG. 6 Detail view of scissor deck access and locking mechanisms

FIG. 7 Elevation views od benchmark range of motions

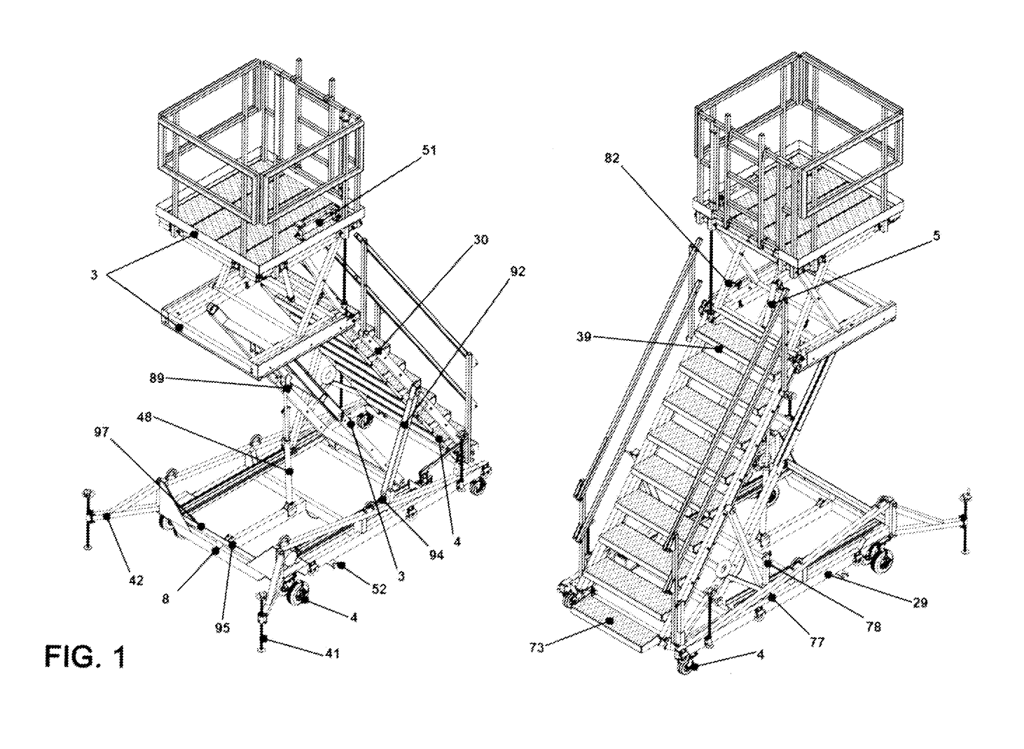

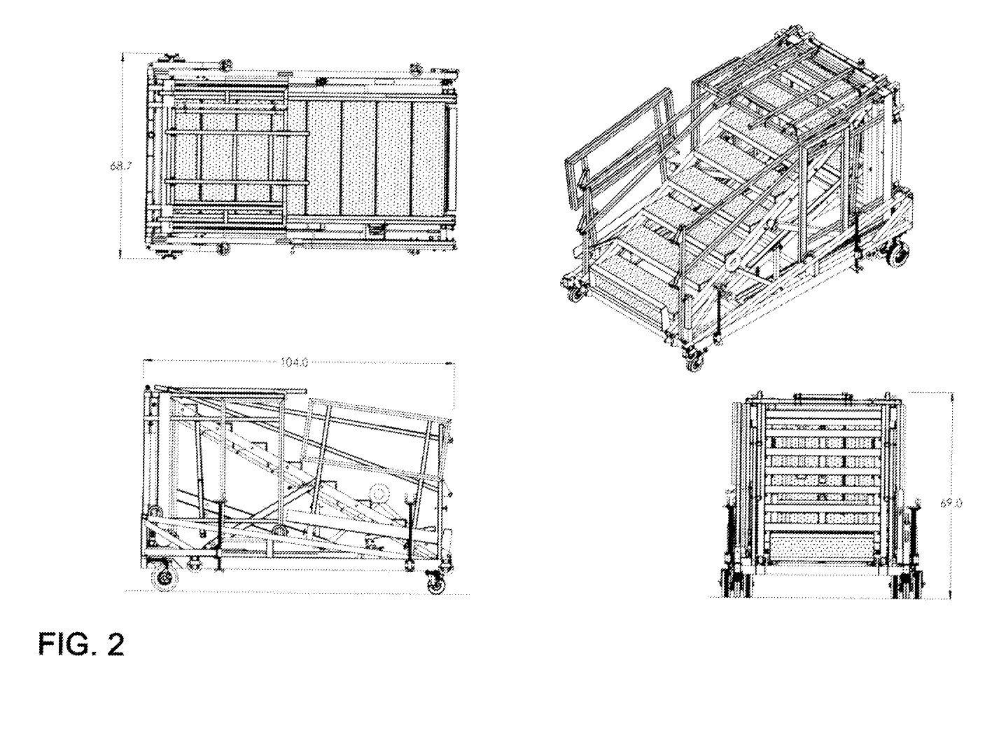

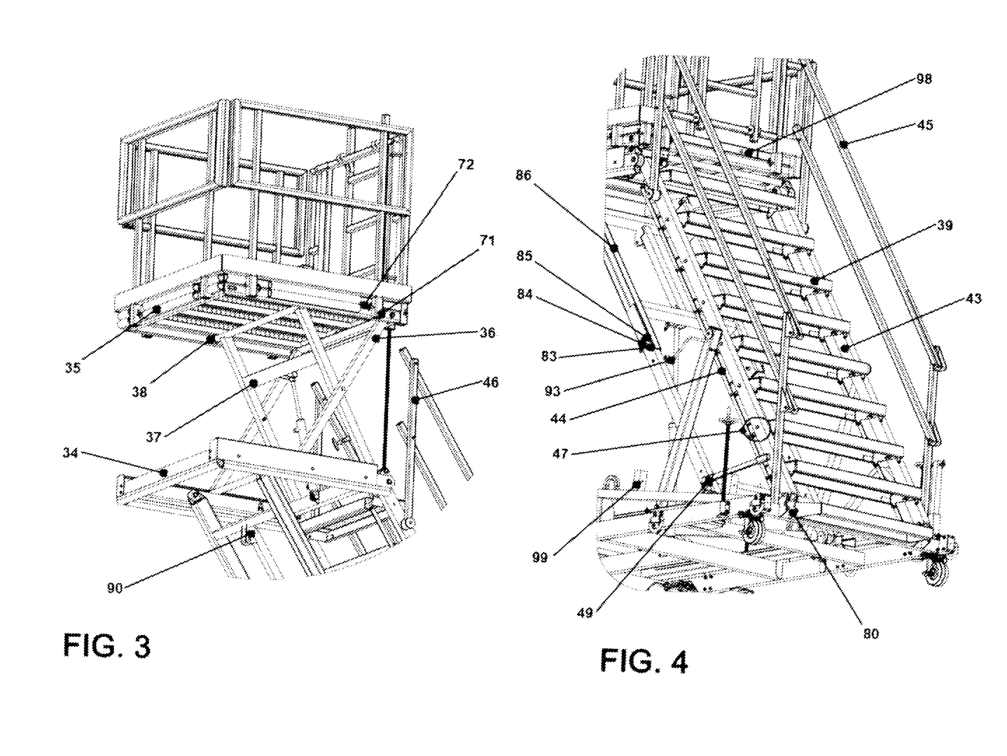

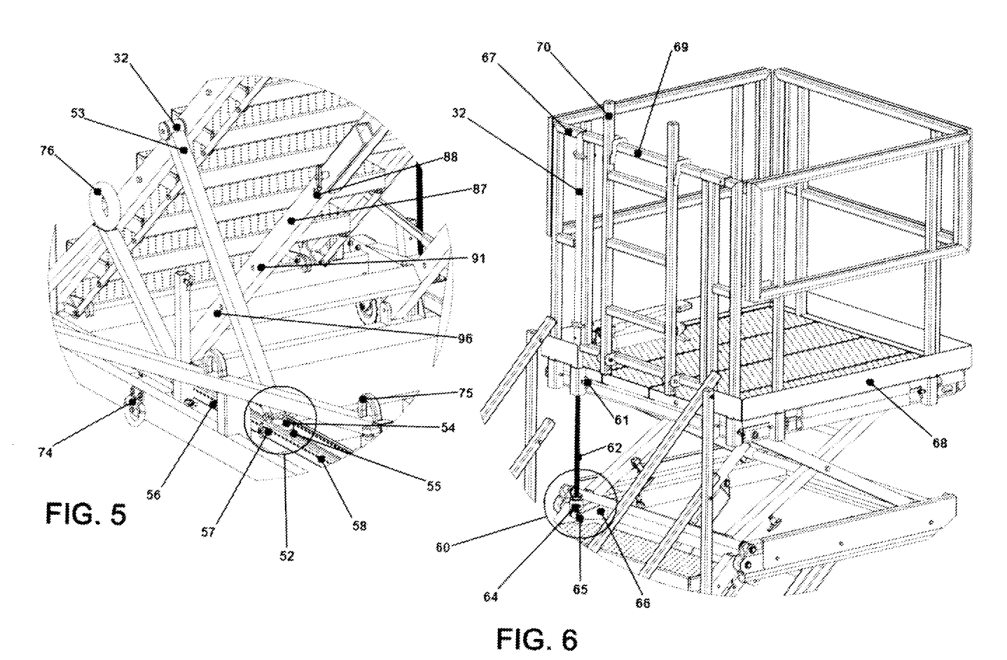

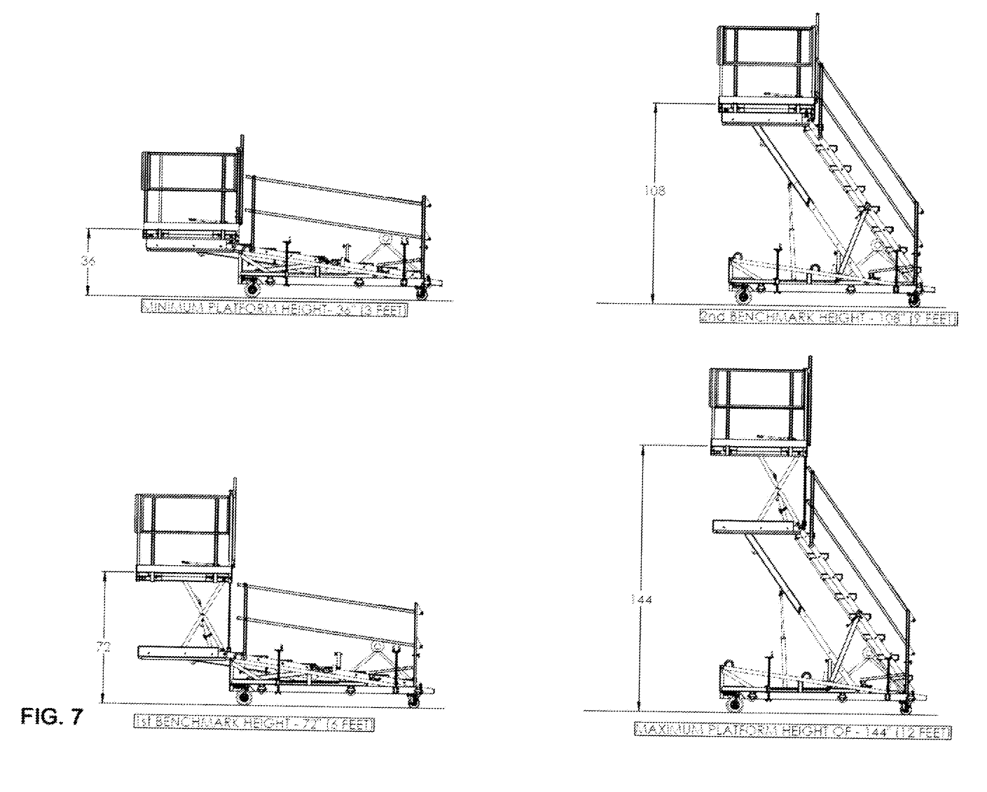

We claim the following in a Non-Provisional Utility Patent that the invention is new and defined as a Machine:

1. A hybrid mobile elevating access platform system comprising of:
An adjustable height stairway element which can be elevated to provide safe aerial access platform for work at height, where in each step of the adjustable stairway element having the means to remain horizontal at all possible platform heights.
An elevating platform element that provides secondary height adjustment. Whereas the elevating platform element having a means to remain parallel to the steps of the adjustable height stairway element at all possible platform heights.
An elevating platform element that is generally located to the upper position of the adjustable height stairway, and where in the elevating platform element is generally accessible by means of an legally permissible step up dimension from the last step of the adjustable height stairway when in the collapsed condition.
An adjustable height stairway element that is independently actuated.
An elevating platform element that is independently actuated.

2. A hybrid mobile elevating access platform system according to claim 1, wherein it has due to is design and identified collapsing sequence the ability to manually compacted safely into a uniquely small foot print for its configuration and reach of 104″ Long×68.71″ wide×69″ height or less, suitable for transport on a Military HCU-6/E-436L pallet or similar.

3. A hybrid mobile elevating access platform system according to claim 2, wherein its design and configuration provide for two distinct, separate and independently operated modes of elevation. Where in operating the adjustable height stairway element, change in elevation is achieved rapidly but in a radial manner. And where in using the elevating platform element elevation is achieved in a vertical up and down manner.

4. A hybrid mobile elevating access platform system according to claim 3, whereas, when in the collapsed configuration it is compacted to a single completely self-contained unit, that is not split into separate elements.

5. A hybrid mobile elevating access platform system according to claim 4, wherein it has a maximum work platform deck height of at least 144″ above ground level, and a minimum work platform height of at most 36″ above ground level.

6. A hybrid mobile elevating access platform system according to claim 5, wherein its functions can be either manually operated or by some other means.

7. A hybrid mobile elevating access platform system according to claim 6, wherein its design and configuration facilitate that it can be either manually propelled or self-propelled

8. A hybrid mobile elevating access platform system according to claim 7, wherein the construction is predominantly of lightweight aluminum material generating a low self-weight of less than 1000 lbs which is ideally suitable for air transport.

9. A hybrid mobile elevating access platform system according to claim 8, wherein one embodiment it is designed and uses a sustainable source of ecologically friendly hydraulic oil.
